(19) United States
(12) Patent Application Publication
(10) Pub. No.: US 2022/0331816 A1
(43) Pub. Date: Oct. 20, 2022

(54) ELECTRICAL DUST COLLECTION DEVICE COMPRISING CHARGING PART AND DUST COLLECTION PART

(71) Applicant: Hanon Systems, Daejeon (KR)

(72) Inventors: Ji-Yong PARK, Daejeon (KR); Ki Hong KIM, Daejeon (KR); Jae Ho KIM, Daejeon (KR)

(21) Appl. No.: 17/763,044

(22) PCT Filed: Oct. 29, 2020
(86) PCT No.: PCT/KR2020/014865

§ 371 Date: Mar. 23, 2022

(30) Foreign Application Priority Data
Nov. 6, 2019 (KR) 10-2019-0140709
Nov. 6, 2019 (KR) 10-2019-0140715

(51) Int. Cl. B03C 3/38; B03C 3/41; B03C 3/12; B03C 3/47; B01D 53/86; B01D 53/88; B01D 53/02

(52) U.S. Cl. CPC B03C 3/38; B03C 3/41; B03C 3/12; B03C 3/47; B01D 53/8675; B01D 53/885; B01D 53/02; B03C 2201/06; B03C 2201/30; B01D 2257/106; B01D 2259/4566

(57) ABSTRACT

The present invention relates to an electrical dust collection device comprising: a charging part for applying charges to dust particles introduced from the outside; a dust collection part for collecting, by electric attraction, the dust particles charged by the charging part, wherein the charging part uses a first charging plate and a second charging plate, in parallel, in the movement direction of dust, thereby increasing an assembly property and further increasing dust collecting efficiency through stable charging, and the dust collection part comprises a first connection portion that continues at one side of a plurality of first dust collection plates, thereby increasing productivity and dust collecting performance.

### TECHNICAL FIELD

The present invention relates to an electrical dust collection device including: a charging part for applying charges to dust particles introduced from the outside; a dust collection part for collecting, by electric attraction, the dust particles charged by the charging part, in which the charging part uses a first charging plate and a second charging plate arranged in parallel in a movement direction of dust, thereby increasing an assembly property and achieves stable charging, thereby further increasing dust collecting efficiency, and the dust collection part includes a first connection portion that continues at one side of a plurality of first dust collection plates, thereby increasing productivity and dust collecting performance.

### BACKGROUND ART

An electrical dust collection device has been widely used in air conditioners of buildings and vehicles, humidifiers, or the like. After the electrical dust collection device charges dust particles so that the dust particles have specific charges selected through a corona discharge phenomenon, the electrical dust collection device collects, by electric attraction, the dust particles in a dust collection part.

As illustrated in FIGS. 1 and 2, the electrical dust collection device described above largely includes a charging part 10 and a dust collection part 20, in which the charging part 10 includes a charging frame 11 that is formed to be penetrated in a direction in which dust particles P are introduced and has a frame shape and a charging plate 12 that is fixed to the charging frame 11 and formed perpendicular to the direction in which the dust particles are introduced.

The charging plate 12 includes one or more charging holes 13 that are formed to be penetrated in a direction in which dust particles are introduced, and pins 14 that are provided at positions corresponding to the charging holes 13 and apply a high voltage to the dust particles to allow the dust particles to have specific charges through a corona charge phenomenon between inner peripheral surfaces of the charging holes 13 and the pins 14. As described above, the dust collection part 20 collects dust particles having specific charges through charging in the charging part 10 by electric attraction using the opposite charge characteristics.

In this case, the electrical dust collection device according to the related art generates a charge phenomenon between the charging holes 13 and the pins 14 of the plate-shaped charging plate 12 to allow the dust particles to have specific electric charges. However, the charging is generated between the cut charging holes 13 and the pins 14 of the horizontal charging plate 12, so a charging amount is not uniform depending on a cut state of the charging holes 13.

In addition, in the electrical dust collection device according to the related art, as described above, the charging holes 13 are formed in the plate-shaped charging plate 12 having an area corresponding to the charging frame 11 so as to penetrate through the charging plate 12 by cutting or the like, and as a result, materials wasted due to the formation of the charging holes 13 are generated, which is disadvantageous in terms of material cost. In addition, the remaining regions of the charging plate 12 excluding the charging holes 13 are formed to be blocked in a direction in which dust is introduced, so a pressure loss may increase.

On the other hand, in general, in order to remove contaminants such as dust and powder contained in air or gas, a filter using a non-woven fabric composed of fine fibers, or the like is used. Since the general fibrous filter has a limit in reducing a size of pores, it was not possible to filter out dust particles smaller than the pores. In addition, when the size of the pores excessively decreases, an air volume decreases and the pores are clogged by large dust particles at an early stage, so the life of the filter may be very short. Therefore, an electrical dust collection filter, which prevents the decrease in the air volume, does not have a problem of the clogging of the pores due to large dust particles, and may filter out even very small impurity particles, has been used.

As illustrated in FIG. 3, the electrical dust collection filter may be configured to have a plurality of separately formed dust collection plates 42a and 42b arranged at a predetermined interval, and alternately apply a cathode high voltage and an anode high voltage to adsorb the dust particles charged to have opposite polarity onto surfaces of the dust collection plates 42a and 42b having a positive polarity or a negative polarity, thereby removing fine particles from air or gas passing between the dust collection plates.

However, as illustrated in FIG. 4, the dust collection plates 42a and 42b have holes formed to penetrate through both surfaces of the dust collection plates 42a and 42b to be electrically connected to each other, and through bars 44a and 44b are inserted to pass through the holes formed in the dust collection plates 42a and 42b. In this case, the cathode dust collection plates 42a are configured to be electrically connected to each other by contacting the through bar 44a connected to a cathode high voltage supply unit, and not to be electrically connected to each other by being spaced apart from the through bar 44b connected to an anode high voltage supply unit. On the other hand, the anode dust collection plates 42b are configured to be electrically connected to each other by contacting the through bar 44b connected to the anode high voltage supply unit, and not to be electrically connected to each other by being spaced apart from the through bar 44a connected to the cathode anode high voltage supply unit.

However, since the through bars are inserted into and coupled to the plurality of separately configured dust collection plates to penetrate through the dust collection plates, the through bars block a flow channel, as a space between the dust collection plates, through which air passes, thereby reducing dust collection performance. In addition, in a portion where the through bar and the dust collection plate are in contact with each other, a non-contact portion where the through bar and the dust collection plate are not in accurate contact with each other may occur, and when foreign substances or conductive materials are introduced into and accumulated in the hole where the dust collection plate and the through bar are not in contact with each other and are spaced apart from each other, the electrical discharge may occur and the dust collecting performance may be degraded. In addition, there is a difficulty in coupling and assembling the dust collection plates and through bars.

In addition, in the case of forming through electrodes to connect electrodes to the plurality of dust collection plates and sealing these through electrodes using a sealing material, the plurality of dust collection plates need to be individually connected to the through electrodes, and it takes time to harden the sealing material, so the production time and cost increase. In addition, such a manufacturing method has a problem in that the use of the sealing material causes odor and the like, and electrical stability may be degraded by individual electrical connections.

### RELATED ART DOCUMENT

KR0495627B1 (2005 Jun. 7)

KR0722863B1 (2007 May 22)

### DISCLOSURE

### Technical Problem

An object of the present invention is to provide an electrical dust collection device including a charging part that may use a first charging plate and a second charging plate arranged in parallel in a movement direction of dust to increase assembly property and productivity, and achieve stable charging to further increase dust collecting efficiency, and a dust collection part that may use a connection portion continuously formed at one side of a plurality of dust collection plates to increase productivity, and increase electrical stability to further increase dust collecting performance.

Another object of the present invention is to provide a charging part that may generate a low voltage in first and second charging plates, respectively, to increase performance of charging dust and minimize a pressure loss of moving air, and may be operated to further reduce the effect of electric noise on adjacent dust collection parts, and an electrical dust collection device including the same.

Another object of the present invention is to provide a charging part that may have an assembly structure in which a first fixed frame for fixing a first charging plate and a second fixed frame for fixing a second charging plate are fastened to each other, in which, in particular, each of the first charging plate and the second charging plate may be assembled using a plate-shaped member divided into a plurality of pieces to remarkably increase assembly property and productivity, and an electrical dust collection device including the same.

Another object of the present invention is to provide a charging part that may be easy to implement in various sizes and configurations without restriction on an area since circles of a first charging hole and a second charging hole are formed in an overlapping shape in a selected direction, and thus, the plurality of overlapping circles are formed inside one of the first charging hole and the second charging hole, and charging pins are formed at centers of the circles, and may not have an overlapping portion with a charging electrode to prevent an abnormal discharge phenomenon.

Another object of the present invention is to provide a charging part that may not have an overlapping portion with a charging electrode to prevent an abnormal discharge phenomenon, and an electrical dust collection device including the same.

Another object of the present invention is to provide a dust collection device for an electric dust collector in which dust collection parts may be simply manufactured in a form in which the collection parts are bonded to each other by using a single sheet, excluding a region in which a connection portion is formed, may not require an individual assembly process for a power supply connection to further increase productivity, and may be easily assembled.

Another object of the present invention is to provide a dust collection device for an electric dust collector in which a first dust collection part and a second dust collection part may be assembled at an accurate position to increase assembly property and increase dust collecting performance.

### Technical Solution

In one general aspect, an electrical dust collection device includes: a charging part that applies charges to dust particles introduced from an outside; and a dust collection part that collects, by electric attraction, the dust particles charged by the charging part, in which the charging part includes: a first charging plate and a second charging plate that are arranged in parallel spaced apart from each other by a predetermined distance in a movement direction of the dust and have a plate shape, and are provided with a first charging hole and a second charging hole penetrated to move the dust, respectively; a charging electrode that includes charging pins protruding from centers of the first charging hole and the second charging hole to apply charges to the dust particles; and a frame-shaped charging frame that is provided with the first charging plate, the second charging plate, and the charging electrode.

The charging electrode may be integrally formed with the charging pins and an electrode rod connecting between the charging pins.

The first charging hole of the first charging plate and the second charging hole of the second charging plate may be curved to have a shape in which circles of the first charging hole and the second charging hole overlaps with each other in a direction perpendicular to a direction in which the dust particles are introduced.

In the charging electrode, the electrode rod may be formed long in the first charging hole and the second charging hole having the shape in which the plurality of circles overlap with each other, and the plurality of charging pins are formed to be positioned at radial centers of the overlapping circles of the first charging hole and the second charging hole.

The charging frame may include a first fixed frame that is provided with a first hollow portion corresponding to the first charging hole of the first charging plate and fixes the first charging plate; and a second fixed frame that is provided with a second hollow portion corresponding to the second charging hole of the second charging plate and fixes the second charging plate, and the first fixed frame to which the first charging plate is fixed and the second fixed frame to which the second charging plate is fixed may be assembled and fixed to each other.

Any one of the first fixed frame and the first charging plate may be provided with a first fastening protrusion, and the other thereof may be provided with a first fastening groove corresponding to the first fastening protrusion to fix the first fastening protrusion and the first fastening groove to each other, and any one of the second fixed frame and the second charging plate may be provided with a second fastening protrusion, and the other thereof may be provided with a second fastening groove corresponding to the second fastening protrusion to fix the second fastening protrusion and the second fastening groove to each other.

The first fixed frame and the second fixed frame may be provided with a first fastening part and a second fastening part for fastening that respectively protrude in a direction facing each other, and the first charging plate and the second charging plate may be provided with a hollow third fastening groove and fourth fastening groove through which the first fastening part and the second fastening part, respectively, penetrate.

The first fastening part and the second fastening part may be configured to remove gaseous materials.

The first fastening part and the second fastening part may be made of a functional catalyst material, or the functional catalyst material may be attached or coated to a structure, and the functional catalyst material may be a material having one of the functions of decomposing, adsorbing, and removing gas to prevent odor-causing gas or ozone from being introduced into the vehicle.

The charging frame may include a connection frame that has both ends fixed to the charging frame to seat the charging electrode, and may be provided with an opening whose predetermined region is opened to expose a charging pin of the charging electrode, and the connection frame may be provided with a first protrusion support portion that alternately supports both surfaces of the electrode rod in a longitudinal direction.

The charging part may further include a charging electrode fixing member that is provided with a fixed groove in which the charging electrode is seated, the charging frame may include a connection frame that has both ends fixed to the charging frame to seat the charging electrode fixing frame and is provided with an opening whose predetermined region is opened to expose a charging pin of the charging electrode, and the charging electrode fixing member may be provided with a second protrusion support portion that alternately supports both surfaces of the electrode rod in a longitudinal direction.

The charging electrode fixing member may be provided with a first corresponding portion in which a predetermined region of the fixed groove protrudes or is recessed, and the charging electrode may be provided with a second corresponding portion having a shape corresponding to the first corresponding portion.

The electrical dust collection device may further include: a reinforcing support portion that connects the overlapping circles of the first hollow portion of the first fixed frame to divide a region of the first hollow portion into a plurality of regions and is formed integrally with the connection frame.

The charging electrode may be formed by a single metal plate.

The dust collection part may include: a first dust collection part that includes a plurality of first dust collection plates arranged in parallel spaced apart from each other by a predetermined distance, and a plurality of first connection portions continuously formed at one side of both end portions of the first dust collection plate to electrically connect the adjacent first dust collection plates in series; and a second dust collection part that includes a plurality of second dust collection plates arranged in parallel spaced apart from each other by a predetermined distance, and a plurality of second connection portions continuously formed at the other side of both end portions of the second dust collection plate to electrically connect the adjacent second dust collection plates in series, and the second dust collection plate may be fitted into the first dust collection part so that the first dust collection plate and the second dust collection plate may be alternately arranged to face each other, but is not in contact with the first dust collection part.

The dust collection part may further include: a first case that is provided with a first opening whose inside is hollow and is provided with a first protrusion fixed portion supporting one side of a first dust collection plate on which a first connection portion of the first dust collection part is formed; and a second case that is provided with a second opening whose inside is hollow and is provided with a second protrusion fixed portion supporting the other side of a second dust collection plate on which a second connection portion of the second dust collection part is formed, the first case may be provided with a first protrusion support portion supporting the other side of the first dust collection plate on which the first connection portion of the first dust collection part is not formed, and the second case may be provided with a second protrusion support portion supporting one side of the second dust collection plate on which the second connection portion of the second dust collection part is not formed.

The first dust collection part may be formed using a single sheet made of a conductive material and a dielectric material surrounding the conductive material, and include a first dust collection plate in which predetermined regions of the sheet is bonded to each other, excluding the first connection portion forming region of the sheet in a longitudinal direction, and the second dust collection part may be formed using the single sheet made of a conductive material and the dielectric material surrounding the conductive material, and include a second dust collection plate in which predetermined regions of the sheet is bonded to each other, excluding the second connection portion forming region of the sheet in the longitudinal direction.

The dust collection part may include: a first dust collection part that includes a plurality of first dust collection plates arranged in parallel spaced apart from each other by a predetermined distance, and a plurality of first connection portions continuously formed at one side of both end portions of the first dust collection plate to electrically connect the adjacent first dust collection plates in series; and a second dust collection part that includes a plurality of second dust collection plates arranged in parallel spaced apart from each other by a predetermined distance, and a plurality of second connection portions alternately formed at both end portions of the second dust collection plate to electrically connect the adjacent second dust collection plates in series, and the second dust collection plate may be fitted into the second dust collection part so that the first dust collection plate and the second dust collection plate may be alternately arranged to face each other, but may be not in contact with the first dust collection part.

The dust collection part may further include: a first fixing member that includes a first support elongated in a longitudinal direction and fixes a position of the first dust collection plate; and a second fixing member that includes a second support elongated in the longitudinal direction and fixes a position of the second dust collection plate.

The first dust collection plate may be provided with a first insertion groove in which the first support of the first fixing member is inserted and fixed at one side in a width direction, and a first cut groove in which the second support of the second fixing member is positioned on the other side in the width direction, and the second dust collection plate may be provided with a second cut groove in which the first support of the first fixing member is positioned at one side in the width direction, and a second insertion groove in which the second support of the second fixing member is inserted and fixed at the other side in the width direction.

### Advantageous Effects

As described above, according to the present invention, in relation to a charging part, an electrical dust collection device may use first and second charging plates arranged in parallel in a movement direction of dust, thereby increasing assembly property and productivity, and achieve stable charging, thereby further increasing dust collecting efficiency.

In particular, according to the present invention, an electrical dust collection device may generate a low voltage in a first charging plate and a second charging plate, respectively, thereby increasing performance of charging dust and minimize a pressure loss of moving air, and operate a charging part, thereby further reducing the effect of electric noise on adjacent dust collection parts.

In addition, according to the present invention, an electrical dust collection device may have an assembly structure in which a first fixed frame for fixing a first charging plate and a second fixed frame for fixing a second charging plate are fastened to each other, and in particular, each of the first charging plate and the second charging plate may be assembled using a plate-shaped member divided into a plurality of pieces, thereby remarkably increasing assembly property and productivity.

In addition, according to the present invention, an electrical dust collection device may be easy to implement in various sizes and configurations without restriction on an area since circles of a first charging hole and a second charging hole are formed in an overlapping shape in a selected direction, and thus, the plurality of overlapping circles are formed inside one of the first charging hole and the second charging hole, and may not have an overlapping portion with a charging electrode, thereby preventing an abnormal discharge phenomenon.

In addition, according to the present invention, an electrical dust collection device may not have an overlapping portion with a charging electrode, thereby preventing an abnormal discharge phenomenon.

According to the present invention, in relation to a dust collection part, an electrical dust collection device may use a connection portion continuously formed at one side of a plurality of dust collection plates, thereby increasing productivity and increase electrical stability, thereby further increasing dust collecting performance.

In particular, according to the present invention, an electrical dust collection device may be simply manufactured in a form in which dust collection parts are bonded to each other by using a single sheet, excluding a region in which a connection portion is formed, may not require an individual assembly process for a power supply connection to further increase productivity, and may be easily assembled.

In addition, according to the present invention, in an electrical dust collection device, a first dust collection part and a second dust collection part may be assembled at an accurate position, thereby increasing assembly property and increasing dust collecting performance.

### BRIEF DESCRIPTION OF THE DRAWINGS

FIGS. 1 and 2 are a plan view and a partial cross-sectional view illustrating a conventional electrical dust collection device.

FIGS. 3 and 4 are a plan view and a partial cross-sectional view illustrating the conventional electrical dust collection device.

FIGS. 5 and 6 are a schematic diagram and an exploded perspective view of an electrical dust collection device according to the present invention.

FIGS. 7 to 10 are a perspective view, a partially enlarged view, an exploded perspective view, and a cross-sectional view taken along AA′ direction of a charging part according to the present invention.

FIG. 11 is a partial schematic diagram of the charging part according to the present invention.

FIGS. 12 and 13 each are partial exploded perspective views of the charging part according to the present invention.

FIGS. 14 and 15 are views for describing another exploded perspective view of the charging part and a charging electrode according to the present invention.

FIG. 16 is another exploded perspective view of the charging part according to the present invention.

FIGS. 17 to 19 are a perspective view, an exploded perspective view, and a schematic diagram illustrating a dust collection part according to the present invention.

FIG. 20 is a diagram illustrating a method of manufacturing a dust collection part according to the present invention.

FIG. 21 is another schematic diagram illustrating the dust collection part according to the present invention.

FIGS. 22 to 25 are another perspective view and an exploded perspective view of the dust collection part according to the present invention, and are an exploded perspective view of the first dust collection part and an exploded perspective view of the second dust collection part.

FIGS. 26 and 27 are a partial perspective view and a side view of the dust collection part according to the present invention.

FIG. 28 is another side view of the dust collection part according to the present invention.

FIGS. 29 and 30 are another exploded perspective view and a side view of the dust collection part according to the present invention.

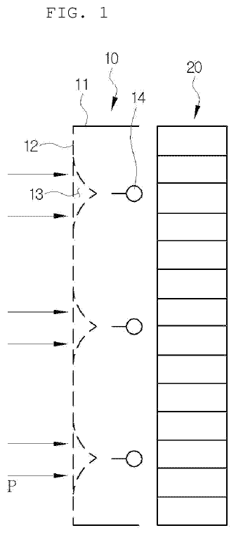

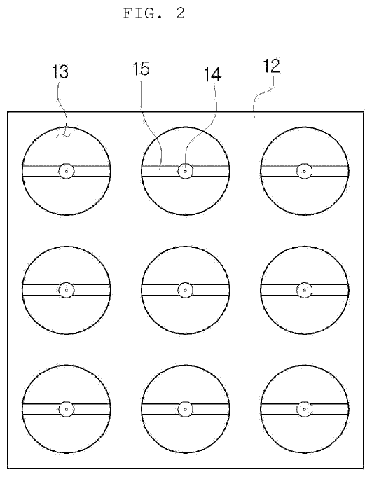

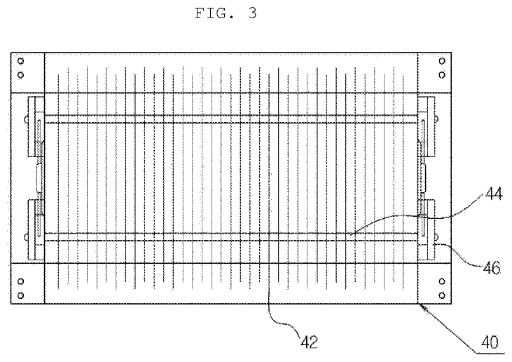

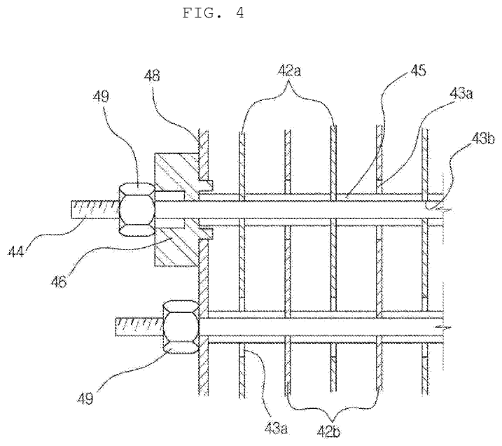

### BEST MODE

Hereinafter, an electrical dust collection device 100 including a charging part 1000 and a dust collection part 2000 according to the present invention having the configuration as described above will be described in detail with reference to the accompanying drawings.

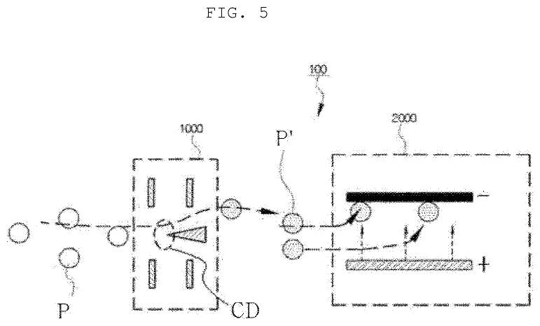

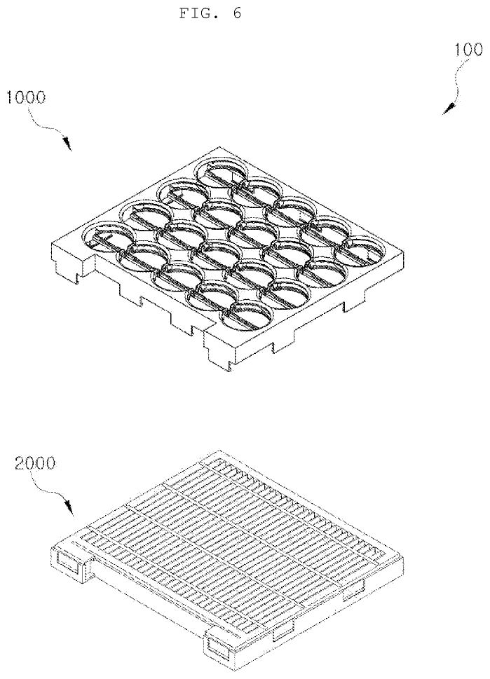

FIGS. 5 and 6 are a schematic diagram and an exploded perspective view of the electrical dust collection device 100 according to the present invention. As illustrated, the electrical dust collection device 100 of the present invention includes the charging part 1000 that applies charges to dust particles P introduced from the outside and the dust collection part 2000 that collects, by electric attraction, dust particles P′ charged by the charging part 1000.

Hereinafter, after first describing the charging part 1000 of the present invention, the dust collection part 2000 will be described.

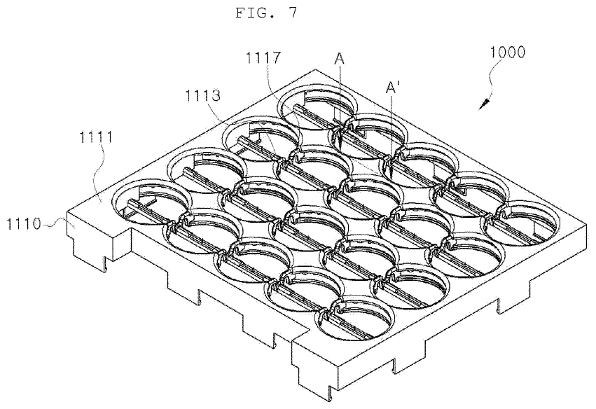

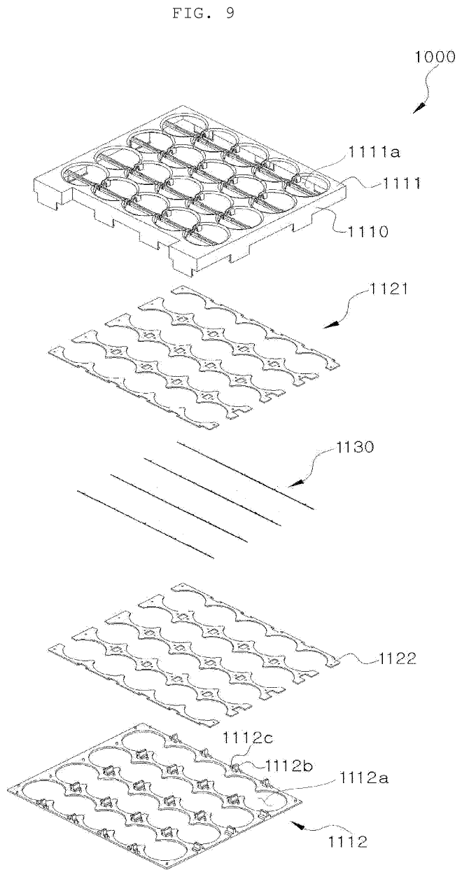

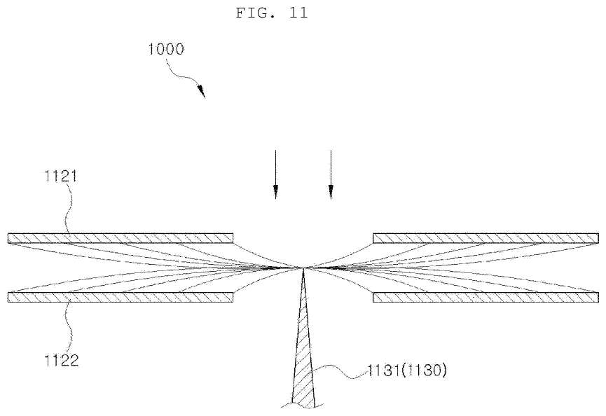

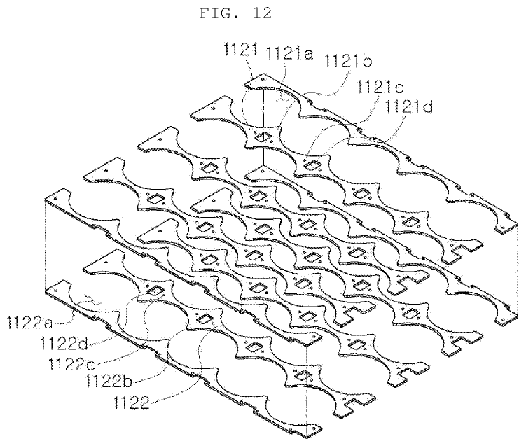

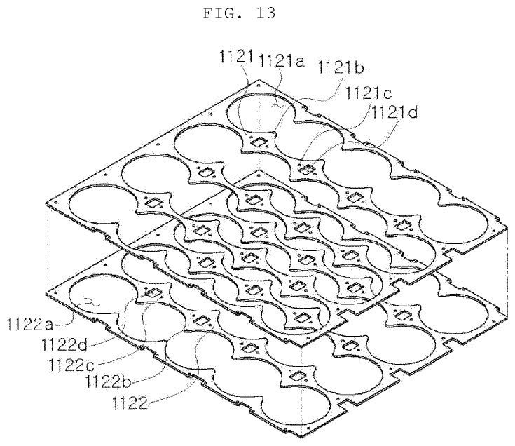

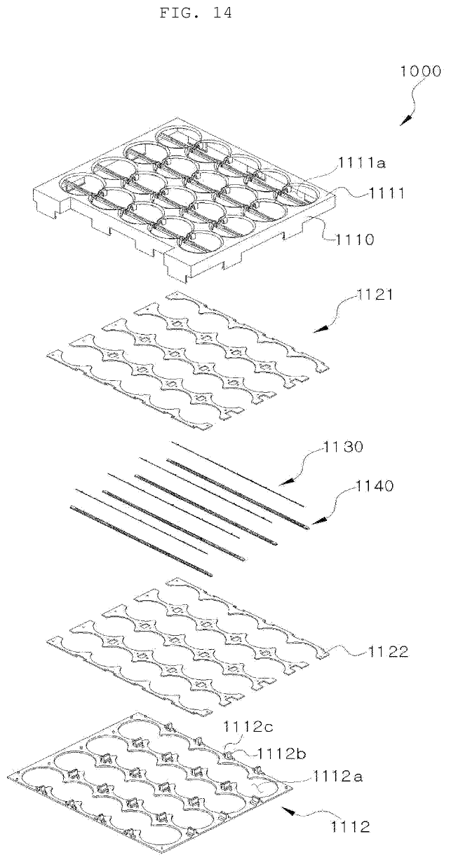

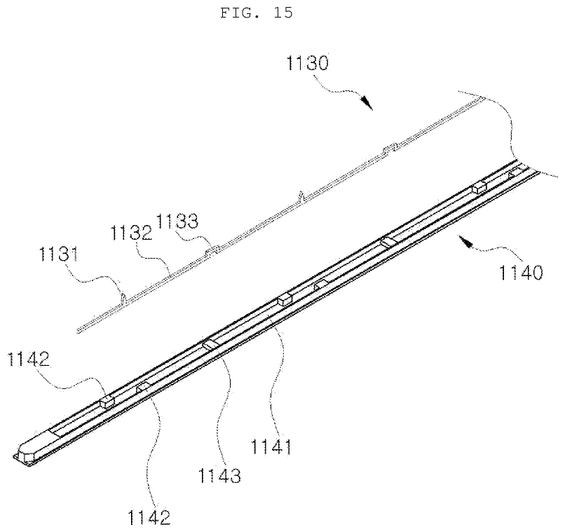

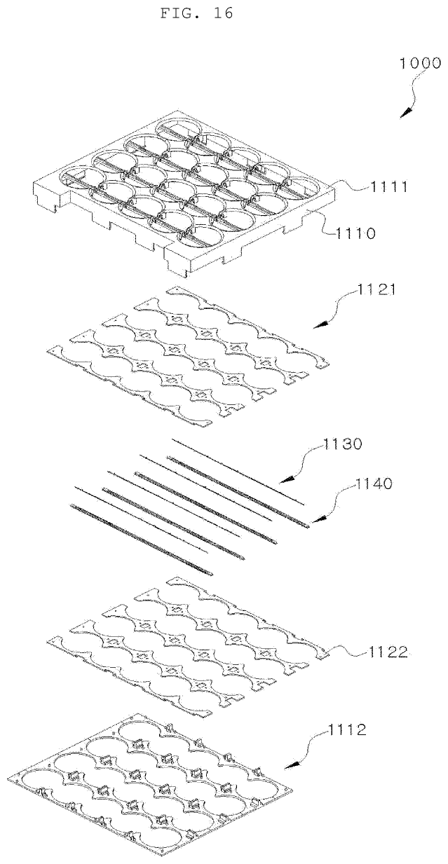

FIGS. 7 to 10 are a perspective view, a partially enlarged view, an exploded perspective view, and a cross-sectional view taken along AA′ direction of the charging part 1000 according to the present invention, FIG. 11 is a partial schematic diagram of the charging part 1000 according to the present invention, FIGS. 12 and 13 each are partial exploded perspective views of the charging part 1000 according to the present invention, FIGS. 14 and 15 are views for describing another exploded perspective view of the charging part 1000 and a charging electrode 1130 according to the present invention, and FIG. 16 is another exploded perspective view of the charging part 1000 according to the present invention.

The charging part 1000 includes a first charging plate 1121, a second charging plate 1122, and a charging electrode 1130.

The first charging plate 1121 and the second charging plate 1122 are provided with a first charging hole 1121a and a second charging hole 1122a that penetrate to move dust therein, and are arranged in parallel spaced apart from each other by a predetermined distance in a dust movement direction and has a plate shape to apply a low voltage (the charging electrode 1130 has a high voltage).

In this case, the first charging plate 1121 and the second charging plate 1122 are formed so that the first charging hole 1121a and the second charging hole 1122a have the same shape, and the first charging hole 1121a and the second charging hole 1122a has a shape in which circles overlap with each other in a selected direction perpendicular to a direction in which dust particles are introduced. That is, the first charging plate 1121 is formed in a shape in which the plurality of first charging holes 1121a are connected, and a portion where circumferential surfaces of the first charging holes 1121a overlap with each other are curved, which is defined as a first overlapping curved portion 1121b. In addition, similar to the shape of the first charging hole 1121a, the second charging plate 1122 is formed in a shape in which the plurality of second charging holes 1122a are connected, and a portion where circumferential surfaces of the second charging holes 1122a overlap with each other are curved, which is defined as a second overlapping curved portion 1122b. In this way, in the electrical dust collection device 100 of the present invention, the charging part 1000 may be more easily manufactured more in various sizes by adjusting an overlap ratio and sizes of the first charging hole 1121a and the second charging hole 1122a, and may prevent unnecessary abnormal charge phenomenon from occurring due to a pointed shape as the first overlapping curved portion 1121b and the second overlapping curved portion 1122b are formed. In addition, an aperture ratio increases compared to the related art, and a loss of air pressure while passing through the charging part 1000 may be minimized.

On the other hand, the first charging plate 1121 and the second charging plate 1122 may each be formed using a single plate (see FIG. 13), and the first charging plate 1121 and the second charging plate 1122 may each be divided into a plurality of members (see FIG. 12). As illustrated in FIG. 12, when the first charging plate 1121 and the second charging plate 1122 are each divided into a plurality of members, it is possible to reduce material cost compared to using a single plate, and more easily perform assembling by using a charging frame 1110 to be described below.

The charging electrode 1130 includes charging pins 1131 that protrude from centers of the first charging hole 1121a formed in the first charging plate 1121 and the second charging hole 1122a formed in the second charging plate 1122 to apply charges to the dust particles.

A pointed end portion of the charging pin 1131 is positioned at radial centers of the first charging hole 1121a and the second charging hole 1122a, and exists in a region between the first charging plate 1121 and the second charging plate 1122 in a movement direction of air.

Also, the charging electrode 1130 is provided with the plurality of charging pins 1131, and the plurality of charging pins 1131 are integrally formed by an electrode rod 1132.

The charging electrode 1130 is configured to be elongated in the first charging hole 1121a (and the second charging hole 1122a continuously formed by the second charging plate 1122) continuously formed by the first charging plate 1121, the charging pin 1131 applies a voltage to the dust particles introduced into the first charging hole 1121a and the second charging hole 1122a, and the electrode rod 1132 connects the charging pins 1131. In this case, it is preferable that the charging electrode 1130 is formed using one metal plate. In this way, in the charging part 1000 of the present invention, as compared with the form in which the plurality of charging pins 1131 are individually assembled to the electrode rod 1132 and are used, the charging pins 1131 may be formed at accurate positions and the production cost and required time may be reduced. In particular, in the charging electrode 1130 of the present invention, the plurality of electrode pins may be provided in one electrode rod 1132 to form one line, such that the assembly manhour and material cost may be reduced and the electrical dust collection device 100 having stable charging performance may be manufactured. In this case, the charging electrode 1130 may be formed by processing the plate in a stamping or etching manner. In this way, in the charging part 1000 of the present invention, a process of welding individual charging pins 1131, or the like is not required, such that the time and cost required for manufacturing the electrical dust collection device may be reduced and the durability may be more increased. In addition, the charging pins 1131 may be accurately positioned at the centers of the overlapping circles forming the charging holes to further increase the charging efficiency. In addition, in the charging part 1000 of the present invention, as illustrated in FIG. 11, a corona discharge phenomenon is uniformly induced by the charging pin 1131 and the first charging plate 1121 and the second charging plate 1122, so the charging effect may be more increased.

Also, the charging part 1000 includes a charging frame 1110.

The charging frame 1110 is a portion on which the first charging plate 1121, the second charging plate 1122, and the charging electrode 1130 are mounted, and is formed in a frame shape.

In addition, the charging frame 1110 may include a first fixed frame 1111 for fixing the first charging plate 1121 and a second fixed frame 1112 for fixing the second charging plate 1122.

First, the first fixed frame 1111 is configured to fix the first charging plate 1121, and may be integrally formed with the charging frame 1110. The first fixed frame 1111 is provided with a first hollow portion 1111a corresponding to the first charging hole 1121a of the first charging plate 1121.

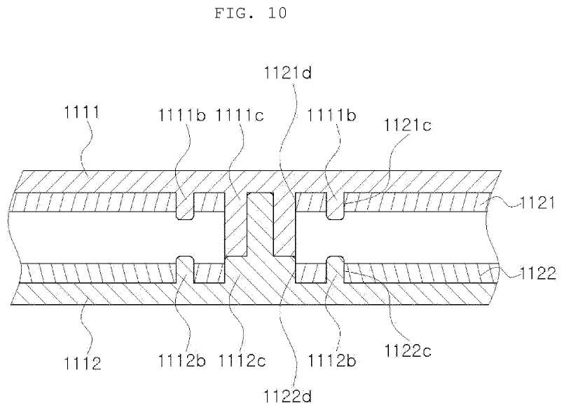

The method of fixing the first fixed frame 1111 and the first charging plate 1121 may be made in various ways, and the first fixed frame 1111 and the first charging plate 1121 has a structure that may be assembled and detached, and thus, may increase assembly property and may be inspected and replaced. As an example, one of the first fixed frame 1111 and the first charging plate 1121 may be provided with a first fastening protrusion 1111b, and the other thereof may be provided with a first fastening groove 1121c corresponding to the first fastening protrusion 1111b, so the first fixed frame 1111 and the first charging plate 1121 may be fixed to each other. FIG. 10 illustrates an example in which the first fixed frame 1111 may be provided with the first fastening protrusion 1111b and the first charging plate 1121 may be provided with the first fastening groove 1121c, and vice versa.

In addition, the second fixed frame 1112 is provided with a second hollow portion 1112a corresponding to the second charging hole 1122a of the second charging plate 1122. In this case, the method of fixing the second fixed frame 1112 and the second charging plate 1122 may also be made in various manners. As an example, one of the second fixed frame 1112 and the second charging plate 1122 may be provided with a second fastening protrusion 1112b, and the other thereof may be provided with a second fastening groove 1122c corresponding to the second fastening protrusion 1112b, so the second fixed frame 1112 and the second charging plate 1122 may be fixed to each other. FIG. 10 illustrates an example in which the second fixed frame 1112 may be provided with the second fastening protrusion 1112b and the second charging plate 1122 may be provided with the second fastening groove 1122c, and vice versa.

Meanwhile, the first fixed frame 1111 and the second fixed frame 1112 may be assembled and fixed to each other. In more detail, the first fixed frame 1111 and the second fixed frame 1112 are provided with a first fastening part 1111c and a second fastening part 1112c for fastening that respectively protrude in a direction facing each other, and the first charging plate 1121 and the second charging plate 1122 are provided with a hollow third fastening groove 1121d and fourth fastening groove 1122d through which the first fastening part 1111c and the second fastening part 1112c, respectively, penetrate. The first fastening part 1111c and the second fastening part 1112c are respectively formed in the first fixed frame 1111 and the second fixed frame 1112 to be assembled, and are provided to maintain a separation distance of the first charging plate 1121 and the second charging plate 1122.

Meanwhile, the second fixed frame 1112 may have a shape including a plurality of members when the second charging plate 1122 is divided into a plurality of pieces (see FIG. 16).

Describing the assembly of the charging part 1000 of the present invention, after the first charging plate 1121 and the first fixed frame 1111 are assembled, and the second charging plate 1122 and the second fixed frame 1112 are assembled, the first fastening part 1111c and the second fastening part 1112c are fastened.

In addition, the first fastening part 1111c and the second fastening part 1112c may serve not only to fix the first charging plate 1121 and the second charging plate 1122, but also to remove gaseous materials. The first fastening part 1111c and the second fastening part 1112c may have a form in which they are formed integrally with the first and second fixing plates, respectively, and then, attached or coated with a functional catalyst material capable of removing the gaseous materials. In addition, the first fastening part 1111c and the second fastening part 1112c may be made of a functional catalyst material and connected to the first and second fixing plates. In this case, the functional catalyst material is defined as a material having one of the functions of decomposing, adsorbing, and removing gas to prevent odor-causing gas or ozone from being introduced into the vehicle.

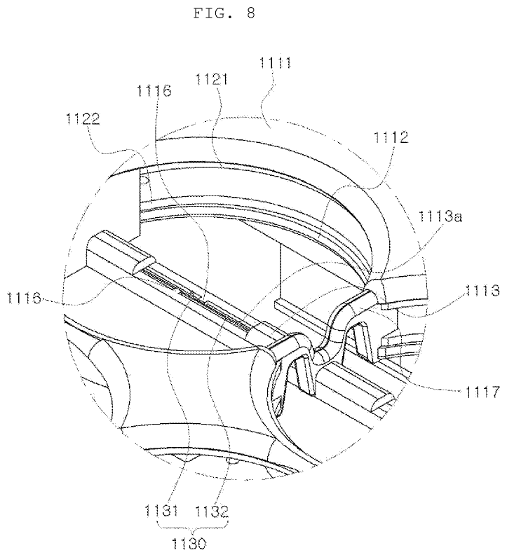

In addition, as illustrated in FIGS. 8 to 10, in the charging part 1000 of the present invention, a connection frame 1113 that is configured to fix the charging electrode 1130 may be further included in the charging frame 1110. The connection frame 1113 has both ends fixed to the charging frame 1110 to seat the charging electrode 1130, and is provided with an opening 1113a whose predetermined region is opened so that the charging pin 1131 of the charging electrode 1130 is exposed. That is, in the form illustrated in FIGS. 8 to 10, the charging electrode 1130 is directly seated on the connection frame 1113. In this case, it is preferable that the connection frame 1113 is provided with a first protrusion support portion 1116 supporting both surfaces of the electrode rod 1132. Two or more first protrusion support portions 1116 may be formed in a longitudinal direction of the electrode rod 1132 so as to easily support the electrode rod 1132 and be easily mounted, and may alternately support both surfaces of the electrode rod 1132 in a state where they are spaced apart from each other by a predetermined distance in the longitudinal direction.

In addition, as illustrated in FIGS. 14 and 15, in the charging part 1000 of the present invention, as a configuration for fixing the charging electrode 1130, the charging electrode fixing member 1140 and the connection frame 1113 may be used.

The charging electrode fixing member 1140 is a portion in which a fixed groove 1141 in which the charging electrode 1130 is seated is formed, and the fixed groove 1141 may be provided with a second protrusion support 1142 that supports both surfaces of the electrode rod 1132. Two or more second protrusion support portions 1142 may be formed in a longitudinal direction of the electrode rod 1132 so as to easily support the electrode rod 1132 and be easily mounted, and may alternately support both surfaces of the electrode rod 1132 in a state where they are spaced apart from each other by a predetermined distance in the longitudinal direction. In this case, it is preferable that the charging electrode fixing member 1140 is provided with a first corresponding portion 1143 in which a predetermined region of the fixed groove 1141 protrudes or is recessed so that the charging electrode 1130 is seated at an accurate position, and the charging electrode 1130 is provided with a second corresponding portion 1133 having a shape corresponding to the first corresponding portion 1143. In FIG. 15, an example in which the first corresponding portion 1143 has a form in which it protrudes and the second corresponding portion 1133 has a form in which the protruding first corresponding portion 1143 may be inserted thereinto is illustrated. In this case, the connection frame 1113 is a portion on which the charging electrode fixing member 1140 is seated, and is formed long so that both ends thereof are fixed to the charging frame 1110. In this case, the connection frame 1113 is provided with the opening 1113a whose predetermined region is opened to expose the charging pin 1131 of the charging electrode 1130.

That is, the charging part 1000 of the present invention may have a form in which the connection frame 1113 is formed to fix the charging electrode 1130, but as illustrated in FIGS. 8 to 10, the charging electrode 1130 is directly seated on the connection frame 1113, or the charging electrode 1130 may be first fixed to the charging electrode fixing member 1140, and the charging electrode fixing member 1140 may be seated on the connection frame 1113. As described above, in the charging part 1000 of the present invention, it is possible to increase productivity by using the charging electrode 1130 in which the charging pin 1131 and the electrode rod 1132 are integrally formed.

On the other hand, as described above, the electrical dust collection device 100 of the present invention includes the charging part 1000 and the dust collection part 2000 that collects, by the electric attraction, the dust particles charged by the charging part 1000. That is, as illustrated in FIG. 5, when the dust particles P pass through the charging part 1000, the dust particles P become charged dust particles P′ by the corona discharge (CD) phenomenon, and are collected by the dust collection part 2000.

In this case, as illustrated in FIG. 14, the dust collection part 2000 may include a filter type in which only air passes and dust particles are collected. In addition, various configurations capable of collecting the charged dust particles may be used.

In particular, the electrical dust collection device 100 of the present invention may increase the assembly property and productivity, may generate a low voltage in the first charging plate 1121 and the second charging plate 1122, respectively, thereby increasing the performance of charging dust, and operate the charging part 1000, thereby further reducing the effect of electric noise on the adjacent dust collection parts 2000.

For example, in the above-described exemplary embodiment, it has been described that the tip of the charging pin 1131 is disposed in the center between the first charging plate 1121 and the second charging plate 1122, but the tip of the charging pin 1131 may be disposed to be biased toward the charging plates 1121 and 1122 close to the direction in which the wind is introduced depending on a moving speed of the introduced dust, that is, a speed of wind. This is considering the movement of dust particles by wind.

Hereinafter, the dust collection part 2000 according to the present invention will be described in detail.

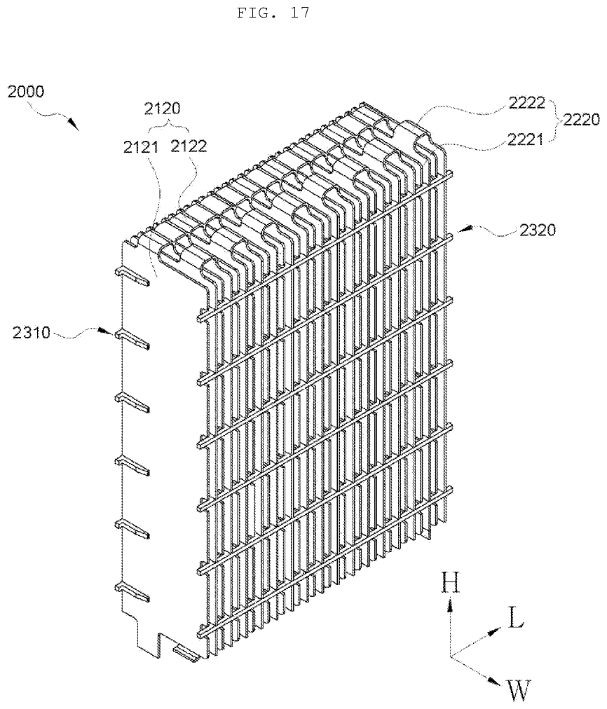

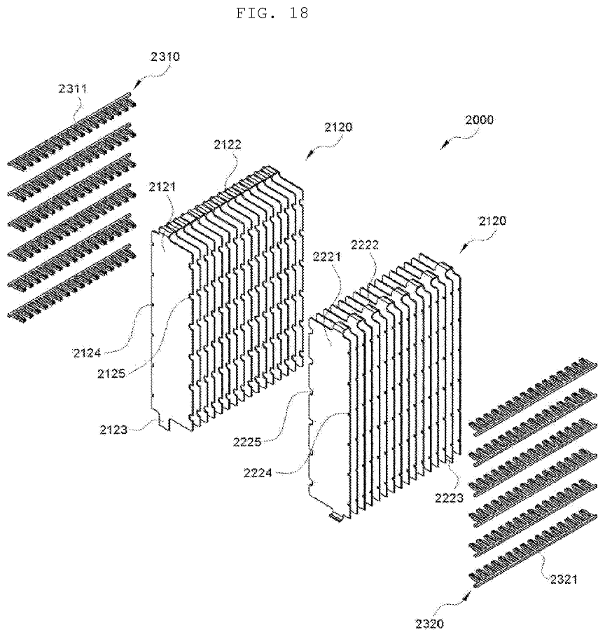

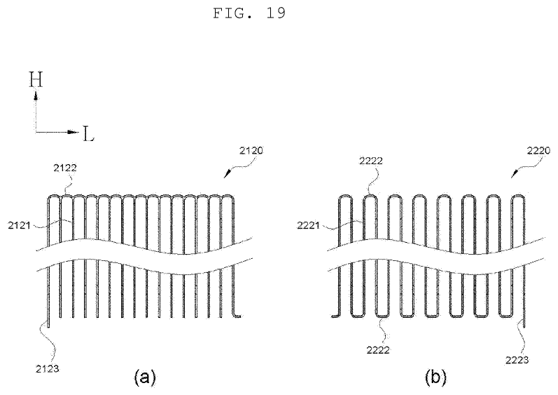

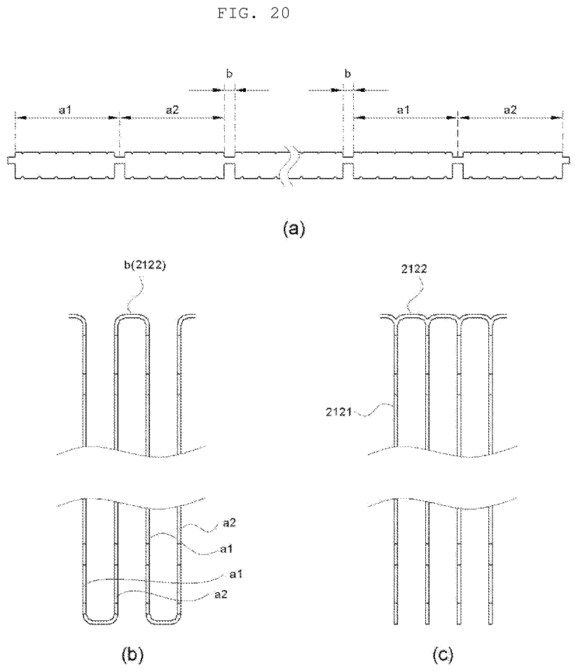

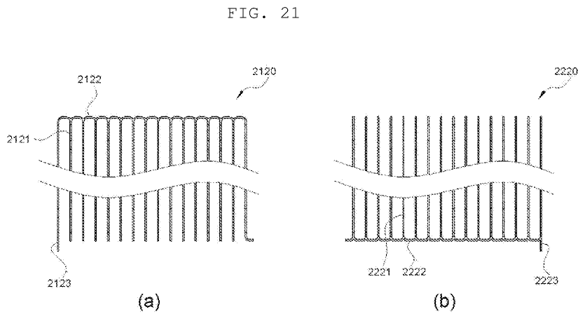

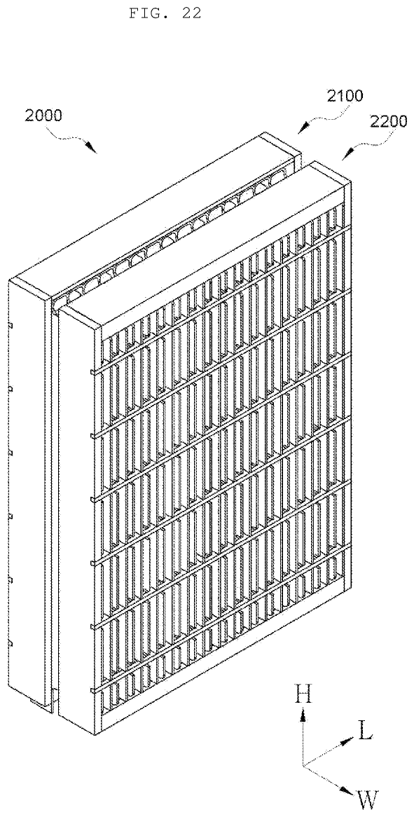

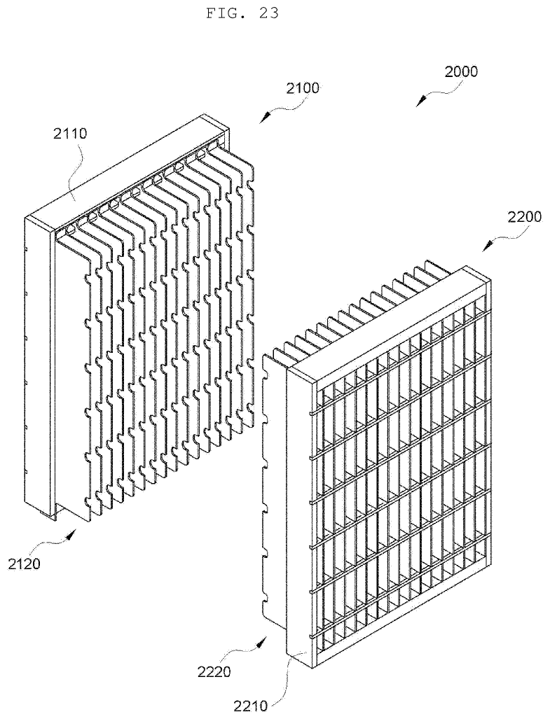

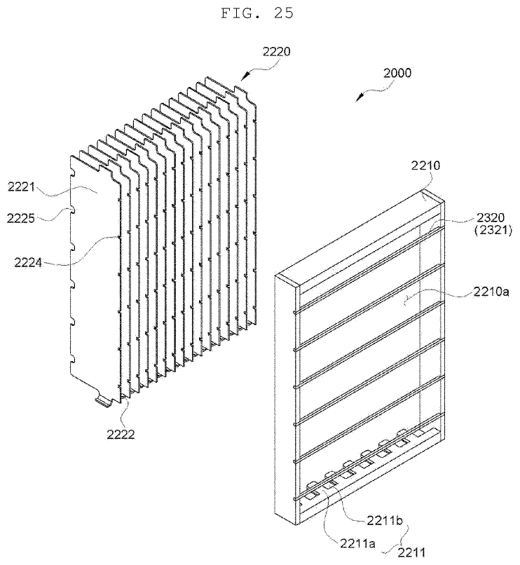

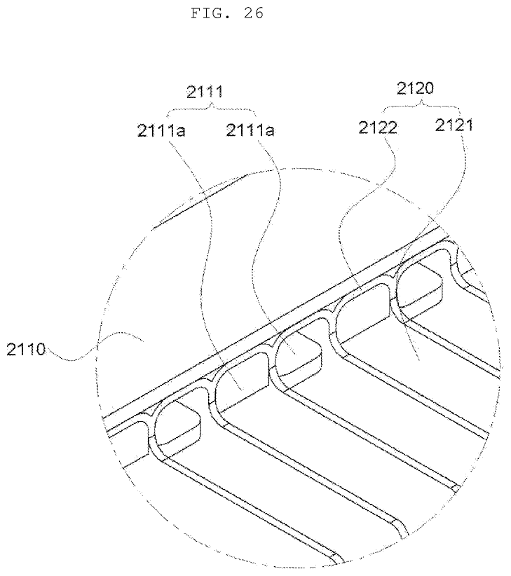

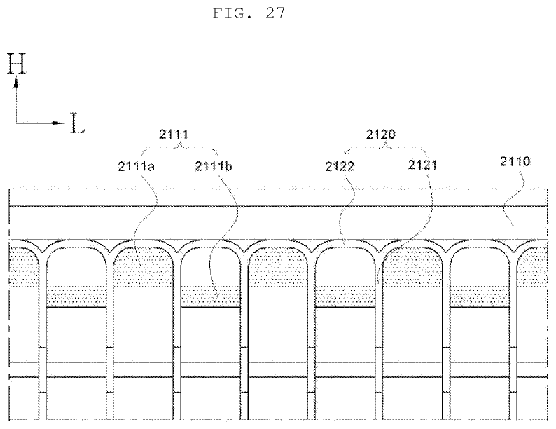

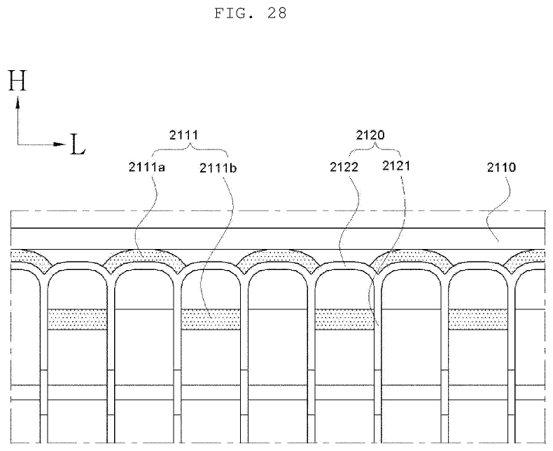

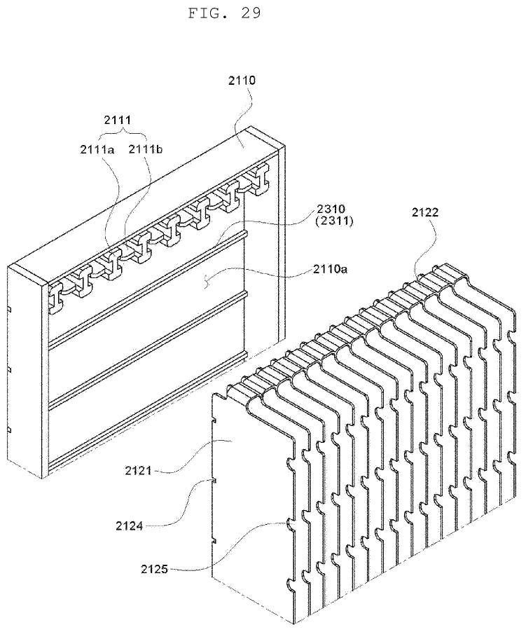

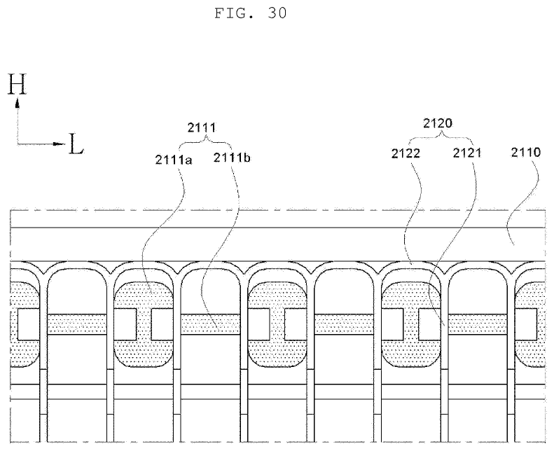

FIGS. 17 to 19 are a perspective view, an exploded perspective view, and a schematic diagram illustrating the dust collection part 2000 according to the present invention. FIG. 20 is a diagram illustrating a method of manufacturing a dust collection part 2000 according to the present invention. FIG. 21 is another schematic diagram illustrating the dust collection part 2000 according to the present invention. FIGS. 22 to 25 are another perspective view and an exploded perspective view of the dust collection part 2000 according to the present invention, and are an exploded perspective view of a first dust collection part 2120 and an exploded perspective view of a second dust collection part 2220. FIGS. 26 and 27 are a partial perspective view and a side view of the dust collection device for electric dust collector according to the present invention. FIG. 28 is another side view of the dust collection device for electric dust collector according to the present invention. FIGS. 29 and 30 are another exploded perspective view and a side view of the dust collection device for electric dust collector according to the present invention.

The dust collection part 2000 of the present invention includes the first dust collection part 2120, and the first dust collection part 2120 includes a first dust collection plate 2121 and a first connection portion 2122.

The plurality of first dust collection plates 2121 are arranged in parallel spaced apart from each other by a predetermined distance.

The first connection portion 2122 is continuously formed at one side of both end portions of the plurality of first dust collection plates 2121 to electrically connect the first dust collection plates 2121 in series. FIGS. 17 to 19 illustrate an example in which the first connection portion 2122 is continuously formed on an upper side in a height direction, which is one side of both end portions of the first dust collection plate 2121. In the dust collection part 2000 of the present invention, the first connection portion 2122 may also be continuously formed on a lower side in a height direction, which is the other side of both end portions of the first dust collection plate 2121.

The first dust collection part 2120 may be manufactured in a form including the first dust collection plate 2121 and the first connection portion 2122 as described above by various methods. As illustrated in FIG. 20, the first collection plate 2121 and the first connection portion 2122 are manufactured using a single sheet, thereby increasing the productivity. In more detail, after a single sheet made of a conductive material and a dielectric material surrounding the conductive material is manufactured as illustrated in FIG. 20A and bent as illustrated in FIG. 20B, except for the region forming the first connection portion 2122, as illustrated in FIG. 20C, certain regions of the sheet are bonded to each other to form the first dust collection plate 2121. That is, two portions a1 and a2 of the sheet are bonded to each other to form one first dust collection plate 2121. In a single sheet, region a1, region a2, and region b are repeated and the region a1, the region a2, and the region b are again repeated to form a first dust collection plate 2121 and a first connection portion 2122 repeatedly. In this case, the sheet is formed in a form in which the conductive material is coated with the dielectric material and the conductive material is surrounded by the dielectric material, and the conductive material may be various materials such as a carbon sheet having electrical conductivity, and the dielectric material may be a thin film of plastic or the like. In addition, a conductive material of a predetermined region may be exposed at the end portion of the sheet to form a first electrode tab 2123 for a power supply connection.

In addition, the dust collection part 2000 of the present invention includes the second dust collection part 2220 to which a high voltage is applied together with the first dust collection part 2120.

The second dust collection part 2220 may be formed in the same shape as the first dust collection part 2120 (see the shapes shown in FIGS. 21 to 25), and includes a second dust collection plate 2221 and a second dust collection part 2220. In more detail, the plurality of second dust collection plates 2221 are arranged in parallel spaced apart from each other by a predetermined distance. The second connection portion 2222 is continuously formed at the other side of both end portions of the second dust collection plates 2221 to electrically connect the adjacent second dust collection plates 2221 in series. In this case, the second dust collection part 2220 is fitted into the first dust collection part 2120 so that the first dust collection plate 2121 and the second dust collection plate 2221 are alternately arranged to face each other, but is arranged to be not in contact with the first dust collection part 2120. That is, the first dust collection plate 2121 and the second dust collection plate 2221 are alternately arranged to be spaced apart from each other by a predetermined distance, and when the first connection portion 2122 of the first dust collection part 2120 is positioned on the upper side in the height direction, the second connection portion 2222 of the second dust collection part 2220 is positioned on the lower side in the height direction.

When a high voltage is applied to the first dust collection part 2120 and the second dust collection part 2220, an electric field is formed therebetween, and cationized dust particles are absorbed and collected on the surface of the first dust collection part 2120 and the second dust collection part 2220 by an electric field as air containing dust particles anionized or cationized by the charging part 100 passes between the first dust collection plate 2121 and the second dust collection plate 2221 (see FIG. 5).

The second dust collection plate 2221 and the second connection portion 2222 of the second dust collection part 2220 are also manufactured using a single sheet in the same manner as illustrated in FIG. 20 to further increase the productivity, and may be a form in which a conductive material of a predetermined region may be exposed to form a second electrode tab 2223 for power connection at the end portion of the sheet.

Therefore, the dust collection part 2000 of the present invention may use the connection portion continuously formed at one side of the plurality of dust collection plates, thereby increasing the productivity, and may increase the electrical stability, thereby further increasing the dust collecting performance. In particular, according to the present invention, the dust collection part 2000 may be simply manufactured in a form in which dust collection parts are joined to each other by using a single sheet except for an area in which a connection portion is formed, may not require an individual assembly process for a power supply connection to further increase productivity, and may be easily assembled.

In addition, the second dust collection part 2220 includes the second dust collection plate 2221 and the second connection portion 2222, and as illustrated in FIGS. 17 to 19, the second connection portion 2222 may be alternately formed on both end portions of the second dust collection plate 2221. In this case, the second dust collection plate 2221 and the second connection portion 2222 may be formed by bending a single sheet.

Meanwhile, the dust collection part 2000 of the present invention may include a first fixing member 2310 and a second fixing member 2320.

The first fixing member 2310 includes a first support 2311 elongated in a longitudinal direction which is a stacking direction of the first dust collection plate 2121 and the second dust collection plate 2221, and fixes a position of the first dust collection plate 2121.

The second fixing member 2320 includes a second support 2321 elongated in the longitudinal direction which is the stacking direction of the first dust collection plate 2121 and the second dust collection plate 2221, and fixes a position of the second dust collection plate 2221.

In order to form the first fixing member 2310 and the second fixing member 2320, the first dust collection plate 2121 is provided with a first insertion groove 2124 in which the first support 2311 of the first fixing member 2310 is inserted and fixed to one side in a width direction and provided with a first cut groove 2125 in which the second support 2321 of the second fixing member 2320 is positioned at the other side in the width direction, and the second dust collection plate 2221 is provided with a second cut groove 2225 in which the first support 2311 of the first fixing member 2310 is positioned on one side in the width direction, and provided with a second insertion groove 2224 in which the second support 2321 of the second fixing member 2320 is inserted and fixed to the other side in the width direction.

In addition, the dust collection part 2000 of the present invention may be in a form including a first case 2110 and a second case 2210 as illustrated in FIGS. 22 to 30. In the drawings, the first case 2110 and the first dust collection part 2120 are designated by the first dust collection module 2100 of reference number 2100, and the second case 2210 and the second dust collection part 2220 are designated by the second dust collection module 2200 of reference number 2200.

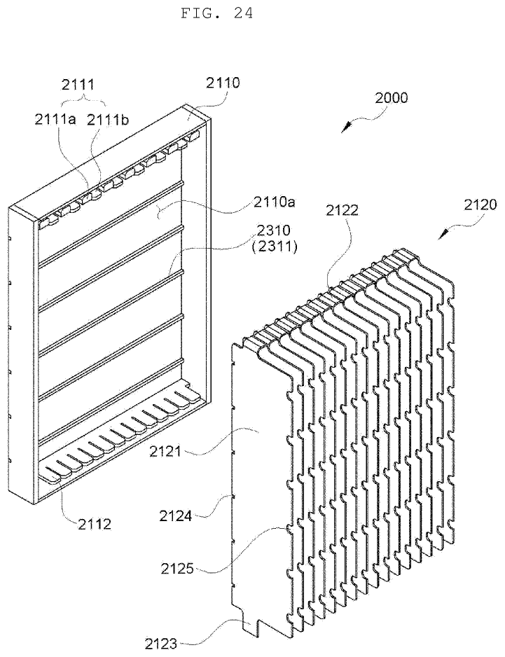

The first case 2110 has a frame shape in which a first opening 2110a whose inside is hollow is formed and is mounted and fixed with the first dust collection part 2120. The first case 2110 includes a first protrusion fixed portion 2111 supporting one side of the first dust collection plate 2121 and a first protrusion support portion 2112 supporting the other side of the first dust collection plate 2121. The first protrusion fixed portion 2111 supports one side of the first dust collection plate 2121, which is a side on which the first connection portion 2122 is formed, and is provided with a 1-1^{th} protrusion fixed portion 2111a and a 1-2^{th} protrusion fixed portion 2111b supporting the first dust collection part 2120 at different heights, and the shape of the first protrusion fixed portion 2111 may be various. The shapes illustrated in FIGS. 24, 26, and 27 are a shape in which the 1-1^{th} protrusion fixed portion 2111a supports one end portion of the first dust collection plate 2121 and an inner periphery of the first connection portion 2122 and a shape in which the 1-2^{th} protrusion fixed portion 2111b protrudes differently from a formation height of the 1-1^{th} protrusion fixed portion 2111a to support the first dust collection plate 2121, and FIGS. 24, 26, and 27 illustrate an example in which the 1-1^{th} protrusion fixed portion 2111a and the 1-2^{th} protrusion fixed portion 2111b are alternately formed in the stacking direction of the first dust collection plate 2121.

The shape illustrated in FIG. 28 is a shape in which the 1-1^{th} protrusion fixed portion 2111a supports the outer periphery of the first connection portion, and a shape in which the 1-2^{th} protrusion fixed portion 2111b supports the first dust collection plate 2121, and FIG. 28 illustrates an example in which the 1-1^{th} protrusion fixed portion 2111a and the 1-2^{th} protrusion fixed portion 2111b are alternately formed in the stacking direction of the first dust collection plate 2121.

The shapes illustrated in FIGS. 29 and 30 are a shape in which the 1-1^{th} protrusion fixed portion 2111a protrudes in the longitudinal direction at the upper and lower sides in the height direction as in the English capital letter “I” and has two regions supporting the first dust collection plate 2121, and the 1-2^{th} protrusion fixed portion 2111b supports the first dust collection plate 2121 between the two regions in the height direction, and FIGS. 29 and 30 illustrate an example in which the 1-1^{th} protrusion fixed portion 2111a and the 1-2^{th} protrusion fixed portion 2111b are alternately formed in the stacking direction of the first dust collection plate 2121.

The first protrusion support portion 2112 supports the other side of the first dust collection plate 2121 on which the first connection portion 2122 of the first dust collection part 2120 is not formed, and may have a shape in which the first dust collection plates 2121 are fitted between the plurality of first protrusion support portions 2112.

In addition, the second case 2210 has a frame shape in which a second opening 2210a whose inside is hollow is formed and is mounted and fixed with the second dust collection part 2220. The second case 2210 includes a second protrusion fixed portion 2211 supporting the other side of the second dust collection plate 2221 and a second protrusion support portion 2212 supporting one side of the second dust collection plate 2221. The second protrusion fixed portion 2211 supports the other side of the second dust collection plate 2221, which is a side on which the second connection portion 2222 is formed, and is provided with a 2-1^{th} protrusion fixed portion 2211a and a 2-2^{th} protrusion fixed portion 2211b supporting the second dust collection part 2220 at different heights, and the shape of the second protrusion fixed portion 2211 may be various. The shapes of the 2-1^{th} protrusion fixed portion 2211a and the 2-2^{th} protrusion fixed portion 2211b are the same as those of the 1-1^{th} protrusion fixed portion 2111a and the 1-2^{th} protrusion fixed portion 2111b, and is formed on the lower side in the height direction as illustrated in FIG. 11 in consideration of the formation position of the second connection portion 2222 of the second dust collection part 2220.

In addition, the second protrusion support portion 2212 supports the other side of the second dust collection plate 2221 on which the second connection portion 2222 of the second dust collection part 2220 is not formed, and may have a shape in which the second dust collection plates 2221 are fitted between the plurality of second protrusion support portions 2212.

In the dust collection part 2000 of the present invention, the first fixing member 2310 may be integrally formed in the first case 2110 and the second fixing member 2320 may be integrally formed in the second case 2210.

The dust collection part 2000 of the present invention may maximally secure the space in which the air flows, thereby further increasing the assembly property and increasing the overall productivity.

The present invention is not limited to the above-mentioned exemplary embodiments but may be variously applied, and may be variously modified by those skilled in the art to which the present invention pertains without departing from the gist of the present invention claimed in the claims.

### DETAILED DESCRIPTION OF MAIN ELEMENTS

100: Electrical dust collection device

1000: Charging part

1110: Charging frame

1111: First fixed frame, 1111a: First hollow portion

1111b: First fastening protrusion, 1111c: First fastening part

1112: Second fixed frame, 1112a: Second hollow portion

1112b: Second fastening protrusion, 1112c: Second fastening part

1113: Connection frame

1113a: Opening

1114: First seating portion, 1115: Second seating portion

1116: First protrusion support portion

1117: Reinforcing support portion

1121: First charging plate, 1121a: First charging hole

1121b: First overlapping curved portion, 1121c: First fastening groove

1121d: Third fastening groove

1122: Second charging plate, 1122a: Second charging hole

1122b: Second overlapping curved portion, 1122c: Second fastening groove

1122d: Fourth fastening groove

1130: Charging electrode

1131: Charging pin, 1132: Electrode rod

1133: Second corresponding portion

1140: Charging electrode fixing member, 1141: Fixed groove

1142: Second protrusion support portion, 1143: First corresponding portion

2000: Dust collection part

2100: First dust collection module

2110: First case, 2110a: First opening

2111: First protrusion fixed portion

2111a: 1-1^{th} protrusion fixed portion, 2111b: 1-2^{th} protrusion fixed portion

2112: First protrusion support portion

2120: First dust collection part

2121: First dust collection plate, 2122: First connection portion

2123: First electrode tab

2124: First insertion groove, 2125: First cut groove

2200: Second dust collection module

2210: Second case, 2210a: Second opening

2211: Second protrusion fixed portion

2211a: 2-1^{th} protrusion fixed portion, 2211b: 2-2^{th} protrusion fixed portion

2212: Second protrusion support portion

2220: Second dust collection part

2221: Second dust collection plate, 2222: Second connection portion

2223: Second electrode tab

2224: Second insertion groove, 2225: Second cut groove

2310: First fixing member, 2311: First support

2320: Second fixing member, 2321: Second support

1. An electrical dust collection device, comprising:
a charging part that applies charges to dust particles introduced from an outside; and
a dust collection part that collects, by electric attraction, the dust particles charged by the charging part,
wherein the charging part includes:
a first charging plate and a second charging plate that are arranged in parallel spaced apart from each other by a predetermined distance in a movement direction of the dust and have a plate shape, and are provided with a first charging hole and a second charging hole penetrated to move the dust, respectively;
a charging electrode that includes charging pins protruding from centers of the first charging hole and the second charging hole to apply charges to the dust particles; and
a frame-shaped charging frame that is provided with the first charging plate, the second charging plate, and the charging electrode.

2. The electrical dust collection device of claim 1, wherein the charging electrode is integrally formed with the charging pins and an electrode rod connecting between the charging pins.

3. The electrical dust collection device of claim 1, wherein the first charging hole of the first charging plate and the second charging hole of the second charging plate are curved to have a shape in which circles of the first charging hole and the second charging hole overlaps with each other in a direction perpendicular to a direction in which the dust particles are introduced.

4. The electrical dust collection device of claim 3, wherein in the charging electrode, the electrode rod is formed long in the first charging hole and the second charging hole having the shape in which the plurality of circles overlap with each other, and the plurality of charging pins are formed to be positioned at radial centers of the overlapping circles of the first charging hole and the second charging hole.

5. The electrical dust collection device of claim 3, wherein the charging frame includes a first fixed frame that is provided with a first hollow portion corresponding to the first charging hole of the first charging plate and fixes the first charging plate; and a second fixed frame that is provided with a second hollow portion corresponding to the second charging hole of the second charging plate and fixes the second charging plate, and
the first fixed frame to which the first charging plate is fixed and the second fixed frame to which the second charging plate is fixed are assembled and fixed to each other.

6. The electrical dust collection device of claim 5, wherein any one of the first fixed frame and the first charging plate is provided with a first fastening protrusion, and the other thereof is provided with a first fastening groove corresponding to the first fastening protrusion to fix the first fastening protrusion and the first fastening groove to each other, and
any one of the second fixed frame and the second charging plate is provided with a second fastening protrusion, and the other thereof is provided with a second fastening groove corresponding to the second fastening protrusion to fix the second fastening protrusion and the second fastening groove to each other.

7. The electrical dust collection device of claim 6, wherein the first fixed frame and the second fixed frame are provided with a first fastening part and a second fastening part for fastening that respectively protrude in a direction facing each other, and
the first charging plate and the second charging plate are provided with a hollow third fastening groove and fourth fastening groove through which the first fastening part and the second fastening part, respectively, penetrate.

8. The electrical dust collection device of claim 7, wherein the first fastening part and the second fastening part are configured to remove gaseous materials.

9. The electrical dust collection device of claim 8, wherein the first fastening part and the second fastening part are made of a functional catalyst material, or the functional catalyst material is attached or coated to a structure, and
the functional catalyst material is a material having one of the functions of decomposing, adsorbing, and removing gas to prevent odor-causing gas or ozone from being introduced into the vehicle.

10. The electrical dust collection device of claim 3, wherein the charging frame includes a connection frame that has both ends fixed to the charging frame to seat the charging electrode, and is provided with an opening whose predetermined region is opened to expose a charging pin of the charging electrode, and
the connection frame is provided with a first protrusion support portion that alternately supports both surfaces of the electrode rod in a longitudinal direction.

11. The electrical dust collection device of claim 3, wherein the charging part further includes a charging electrode fixing member that is provided with a fixed groove in which the charging electrode is seated,
the charging frame includes a connection frame that has both ends fixed to the charging frame to seat the charging electrode fixing frame and is provided with an opening whose predetermined region is opened to expose a charging pin of the charging electrode, and
the charging electrode fixing member is provided with a second protrusion support portion that alternately supports both surfaces of the electrode rod in a longitudinal direction.

12. The electrical dust collection device of claim 11, wherein the charging electrode fixing member is provided with a first corresponding portion in which a predetermined region of the fixed groove protrudes or is recessed, and
the charging electrode is provided with a second corresponding portion having a shape corresponding to the first corresponding portion.

13. The electrical dust collection device of claim 12, further comprising:
a reinforcing support portion that connects the overlapping circles of the first hollow portion of the first fixed frame to divide a region of the first hollow portion into a plurality of regions and is formed integrally with the connection frame.

14. The electrical dust collection device of claim 3, wherein the charging electrode is formed by a single metal plate.

15. The electrical dust collection device of claim 1, wherein the dust collection part includes:
a first dust collection part that includes a plurality of first dust collection plates arranged in parallel spaced apart from each other by a predetermined distance, and a plurality of first connection portions continuously formed at one side of both end portions of the first dust collection plate to electrically connect the adjacent first dust collection plates in series; and
a second dust collection part that includes a plurality of second dust collection plates arranged in parallel spaced apart from each other by a predetermined distance, and a plurality of second connection portions continuously formed at the other side of both end portions of the second dust collection plate to electrically connect the adjacent second dust collection plates in series, and
the second dust collection plate is fitted into the first dust collection part so that the first dust collection plate and the second dust collection plate are alternately arranged to face each other, but is not in contact with the first dust collection part.

16. The electrical dust collection device of claim 15, wherein the dust collection part further includes:
a first case that is provided with a first opening whose inside is hollow and is provided with a first protrusion fixed portion supporting one side of a first dust collection plate on which a first connection portion of the first dust collection part is formed; and
a second case that is provided with a second opening whose inside is hollow and is provided with a second protrusion fixed portion supporting the other side of a second dust collection plate on which a second connection portion of the second dust collection part is formed,
the first case is provided with a first protrusion support portion supporting the other side of the first dust collection plate on which the first connection portion of the first dust collection part is not formed, and
the second case is provided with a second protrusion support portion supporting one side of the second dust collection plate on which the second connection portion of the second dust collection part is not formed.

17. The electrical dust collection device of claim 15, wherein the first dust collection part is formed using a single sheet made of a conductive material and a dielectric material surrounding the conductive material, and includes a first dust collection plate in which predetermined regions of the sheet is bonded to each other, excluding the first connection portion forming region of the sheet in a longitudinal direction, and
the second dust collection part is formed using the single sheet made of a conductive material and the dielectric material surrounding the conductive material, and includes a second dust collection plate in which predetermined regions of the sheet is bonded to each other, excluding the second connection portion forming region of the sheet in the longitudinal direction.

18. The electrical dust collection device of claim 1, wherein the dust collection part includes:
a first dust collection part that includes a plurality of first dust collection plates arranged in parallel spaced apart from each other by a predetermined distance, and a plurality of first connection portions continuously formed at one side of both end portions of the first dust collection plate to electrically connect the adjacent first dust collection plates in series; and
a second dust collection part that includes a plurality of second dust collection plates arranged in parallel spaced apart from each other by a predetermined distance, and a plurality of second connection portions alternately formed at both end portions of the second dust collection plate to electrically connect the adjacent second dust collection plates in series, and
the second dust collection plate is fitted into the second dust collection part so that the first dust collection plate and the second dust collection plate are alternately arranged to face each other, but is not in contact with the first dust collection part.

19. The electrical dust collection device of claim 15, wherein the dust collection part further includes:
a first fixing member that includes a first support elongated in a longitudinal direction and fixes a position of the first dust collection plate; and
a second fixing member that includes a second support elongated in the longitudinal direction and fixes a position of the second dust collection plate.

20. The electrical dust collection device of claim 19, wherein the first dust collection plate is provided with a first insertion groove in which the first support of the first fixing member is inserted and fixed at one side in a width direction, and a first cut groove in which the second support of the second fixing member is positioned on the other side in the width direction, and
the second dust collection plate is provided with a second cut groove in which the first support of the first fixing member is positioned at one side in the width direction, and a second insertion groove in which the second support of the second fixing member is inserted and fixed at the other side in the width direction.
